(19) United States
(12) Patent Application Publication
(10) Pub. No.: US 2022/0036179 A1
(43) Pub. Date: Feb. 3, 2022

(54) ONLINE TASK INFERENCE FOR COMPOSITIONAL TASKS WITH CONTEXT ADAPTATION

(71) Applicant: NVIDIA CORPORATION, Santa Clara, CA (US)

(72) Inventors: Animesh GARG, Fremont, CA (US); Hongyu REN, Stanford, CA (US); Yuke ZHU, Mountain View, CA (US); Anima ANANDKUMAR, Santa Clara, CA (US)

(21) Appl. No.: 16/945,753

(22) Filed: Jul. 31, 2020

(51) Int. Cl. G06N 3/08; G06N 5/04; G06N 3/04

(52) U.S. Cl. CPC G06N 3/08; G06N 3/04; G06N 5/04

(57) ABSTRACT

One embodiment of a method for performing a task includes generating a first posterior distribution of a global latent context variable for the task based on a pool of contexts sampled from one or more previous episodes of the task. The method also includes generating a second posterior distribution of a local latent context variable for a current time step in a current episode of the task based on one or more recent contexts sampled at one or more previous time steps of the current episode. The method further includes causing an agent to perform an action related to carrying out the task based on the first posterior distribution, the second posterior distribution, and a current state associated with the current time step.

### BACKGROUND

### Field of the Various Embodiments

Embodiments of the present disclosure relate generally to online task inference, and more specifically, to online task inference for compositional tasks with context adaptation.

### Description of the Related Art

Real-world tasks often have a compositional structure that contains a sequence of simpler sub-tasks. For example, a task of opening a door requires sub-tasks of reaching, grasping, rotating, and pushing or pulling the door knob. To perform these compositional tasks successfully, a reinforcement learning agent needs to infer the sub-task at hand and orchestrate its behavior accordingly. This can be referred to as an “online task inference” problem, where the current task identity, represented by a context variable, is estimated from the agent's past experiences with probabilistic inference.

Existing approaches to online task inference involve the use of simple Gaussian distributions to model a single latent context variable for an entire task. The agent then makes sequential decisions for the task given the latent context variable. However, these latent context variables are held constant across individual episodes, which fails to adequately model sequences of sub-tasks required to perform real-world tasks. Moreover, isotropic Gaussian random variables are not flexible enough to model mixtures of tasks.

As the foregoing illustrates, what is needed in the art are techniques for modeling compositional task structures in reinforcement learning models.

### SUMMARY

One embodiment of the present invention sets forth a technique for performing a task. The technique includes generating a first posterior distribution of a global latent context variable for the task based on a pool of contexts sampled from one or more previous episodes of the task. The technique also includes generating a second posterior distribution of a local latent context variable for a current time step in a current episode of the task based on one or more recent contexts sampled at one or more previous time steps of the current episode. The technique further includes causing an agent to perform an action related to carrying out the task based on the first posterior distribution, the second posterior distribution, and a current state associated with the current time step.

One technological advantage of the disclosed techniques is that the agent converges on an “optimal” policy for solving an unseen task more quickly than conventional techniques that lack the ability to model compositional multi-stage tasks using local and global latent context variables and/or that do not support flexible parameterization of the latent space for the context variables. Thus, by reducing resource overhead and/or improving performance associated with training and/or executing the meta-RL model, the disclosed techniques provide technological improvements in computer systems, applications, frameworks, and/or techniques for performing meta-RL and/or online task inference.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a system configured to implement one or more aspects of various embodiments.

FIG. 2 is a more detailed illustration of the training engine and inference engine of FIG. 1, according to various embodiments.

FIG. 3 is a flow chart of method steps for performing a task, according to various embodiments.

FIG. 4 is a flow chart of method steps for training a meta-reinforcement learning (meta-RL) model, according to various embodiments.

FIG. 5 is an example system diagram for a game streaming system, according to various embodiments.

### DETAILED DESCRIPTION

In the following description, numerous specific details are set forth to provide a more thorough understanding of the various embodiments. However, it will be apparent to one of skilled in the art that the inventive concepts may be practiced without one or more of these specific details.

General Overview

In machine learning, reinforcement learning (RL) agents are commonly trained to perform tasks such as playing games, navigating within spaces, and/or operating robots. To learn or perform a task, an RL agent may interact with an environment to achieve one or more goals. For example, an RL agent may move around a maze or another space to find an exit or another “goal” location in the maze.

Many real-world tasks can be considered “compositional” tasks that are performed as sequences of simpler sub-tasks. For example, a task of sorting and organizing items in a warehouse may include sub-tasks of grasping each item, identifying the grasped item, and moving the item to a corresponding bin or shelf.

To improve the agent's decision-making during compositional tasks, the agent may “learn” a global and local context associated with the tasks during training and use the learned contexts to select actions that are used to solve new unseen tasks. More specifically, training of the agent may include training one or more neural networks that encode, or “remember,” a global context and a local context related to the training tasks, as well as training the agent to select actions for solving the training tasks based on the global and local contexts. The global context may include information that characterizes a given task, such as goal locations or rewards associated with the task. The local context may include information that captures the current sub-task within the task, such as the next goal to achieve.

For example, the agent may be exposed to a set of mazes with different layouts during training. As the agent interacts with the mazes, the agent collects context information, which includes a current state that represents the agent's location or situation with respect to the environment (e.g., a maze in which the agent is currently placed), an action performed by the agent, a next state encountered by the agent as result of the action and the current state, and a reward (e.g., a value that is increased when the agent achieves a goal). This context information may be provided to a first neural network, which acts as a global context encoder that learns representations of the “global,” or overall, structure of each task, such as the layout of the maze or one or more goal locations to reach within the maze. The context information may also be provided by a second neural network, which acts as a local context encoder that learns the “local,” or immediate, context at any given time, such as the agent's current position, orientation, velocity, progress, and/or goal within a maze.

After training is complete, the agent may be given multiple attempts at performing a new “unseen” task that is related (but not identical) to tasks with which the agent was trained. During these attempts, the agent uses the encoded global and local information obtained during training to select and/or perform actions related to carrying out the task. This may involve generating a new representation of the global task structure at the beginning of each attempt at the task based on prior exposure to the task from previous attempts, as well as generating a new representation of the local task structure at the beginning of each “step” within a given attempt based on interaction between the agent and the environment associated with the task at one or more previous time steps of the same attempt.

Continuing with the above example, the agent may be placed into a previously unseen maze with a different layout than the mazes used to train the agent. Each attempt by the agent to solve the maze may include a series of “steps,” where each step is associated with a context that includes the agent's current state, a selection of an action by the agent based on the current state, the next state reached by the agent based on the action and current state, and the reward associated with the next state. This context information may be collected by the agent and/or provided to the global and local context encoders, which update representations of the global and local contexts for the task over time. As the global and local contexts are updated, the agent gains a better sense of the “global,” or overall, layout of the maze or one or more goal locations to reach within the maze. The agent also gains a better sense of the “local,” or immediate, position, goal, or progress at each step within a given attempt. The agent may then use the global and local information to decide on a certain type of action (e.g., moving forward, moving backward, turning left, turning right, etc.) at each step, so that over time, the agent develops an effective strategy for solving the maze. In turn, the agent may solve the maze more quickly and efficiently than other RL agents or techniques that do use accumulated global and local context information to perform tasks.

### System Overview

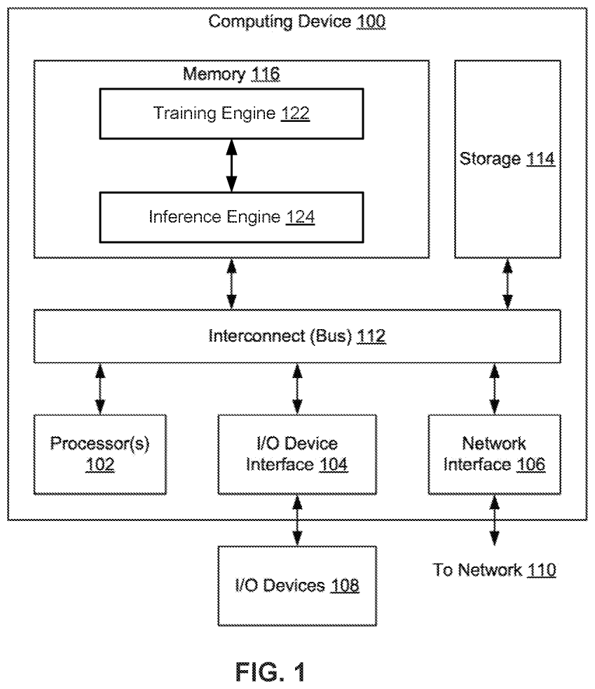

FIG. 1 illustrates a computing device 100 configured to implement one or more aspects of various embodiments. In one embodiment, computing device 100 may be a desktop computer, a laptop computer, a smart phone, a personal digital assistant (PDA), tablet computer, or any other type of computing device configured to receive input, process data, and optionally display images, and is suitable for practicing one or more embodiments. Computing device 100 is configured to run a training engine 122 and inference engine 124 that reside in a memory 116. It is noted that the computing device described herein is illustrative and that any other technically feasible configurations fall within the scope of the present disclosure. For example, multiple instances of training engine 122 and inference engine 124 may execute on a set of nodes in a distributed system to implement the functionality of computing device 100.

In one embodiment, computing device 100 includes, without limitation, an interconnect (bus) 112 that connects one or more processing units 102, an input/output (I/O) device interface 104 coupled to one or more input/output (I/O) devices 108, memory 116, a storage 114, and a network interface 106. Processing unit(s) 102 may be any suitable processor implemented as a central processing unit (CPU), a graphics processing unit (GPU), an application-specific integrated circuit (ASIC), a field programmable gate array (FPGA), an artificial intelligence (AI) accelerator, any other type of processing unit, or a combination of different processing units, such as a CPU configured to operate in conjunction with a GPU. In general, processing unit(s) 102 may be any technically feasible hardware unit capable of processing data and/or executing software applications. Further, in the context of this disclosure, the computing elements shown in computing device 100 may correspond to a physical computing system (e.g., a system in a data center) or may be a virtual computing instance executing within a computing cloud.

In one embodiment, I/O devices 108 include devices capable of providing input, such as a keyboard, a mouse, a touch-sensitive screen, and so forth, as well as devices capable of providing output, such as a display device. Additionally, I/O devices 108 may include devices capable of both receiving input and providing output, such as a touchscreen, a universal serial bus (USB) port, and so forth. I/O devices 108 may be configured to receive various types of input from an end-user (e.g., a designer) of computing device 100, and to also provide various types of output to the end-user of computing device 100, such as displayed digital images or digital videos or text. In some embodiments, one or more of I/O devices 108 are configured to couple computing device 100 to a network 110.

In one embodiment, network 110 is any technically feasible type of communications network that allows data to be exchanged between computing device 100 and external entities or devices, such as a web server or another networked computing device. For example, network 110 may include a wide area network (WAN), a local area network (LAN), a wireless (WiFi) network, and/or the Internet, among others.

In one embodiment, storage 114 includes non-volatile storage for applications and data, and may include fixed or removable disk drives, flash memory devices, and CD-ROM, DVD-ROM, Blu-Ray, HD-DVD, or other magnetic, optical, or solid state storage devices. Training engine 122 and inference engine 124 may be stored in storage 114 and loaded into memory 116 when executed.

In one embodiment, memory 116 includes a random access memory (RAM) module, a flash memory unit, or any other type of memory unit or combination thereof. Processing unit(s) 102, I/O device interface 104, and network interface 106 are configured to read data from and write data to memory 116. Memory 116 includes various software programs that can be executed by processor(s) 102 and application data associated with said software programs, including training engine 122 and inference engine 124.

Training engine 122 includes functionality to train a meta-reinforcement learning (meta-RL) model, and inference engine 124 includes functionality to execute the meta-RL model to perform online task inference for compositional tasks with context adaptation. In various embodiments, compositional tasks include tasks that involve sequences of sub-tasks. For example, a task of opening a door includes sub-tasks of reaching, grasping, rotating, and pushing or pulling the door knob.

In turn, online task inference includes probabilistically estimating a task and/or sub-task to be currently performed based on past experience with the same task and/or similar tasks, and meta-RL includes using RL to adapt to a new task given prior exposure to similar (but not identical) tasks. Continuing with the above example, online task inference for the door-opening task may include estimating parameters affecting opening of the door (e.g., hinged or sliding door, opening inward or outward, type and location of door knob, etc.), as well as estimating the current sub-task to be performed in a given time step of the door-opening task.

More specifically, training engine 122 may train the meta-RL model to estimate posterior distributions of a global latent context variable and a local latent context variable. The global latent context variable may represent a mixture of sub-tasks required to perform a task (e.g., parameters affecting a door-opening task), and the local latent context variable may capture transitions between the sub-tasks (e.g., a current sub-task to be performed after one or more sub-tasks have already been completed). As described in further detail below, these latent context variables may inform an agent in the meta-RL model of the context associated with the task, which allows the agent to converge on the optimal policy for performing the task. In turn, the agent is able to adapt more quickly to unseen tasks and exhibit better performance in executing the tasks than existing meta-RL models that fail to capture or model complex compositional task structures.

### Online Task Inference for Compositional Tasks with Context Adaptation

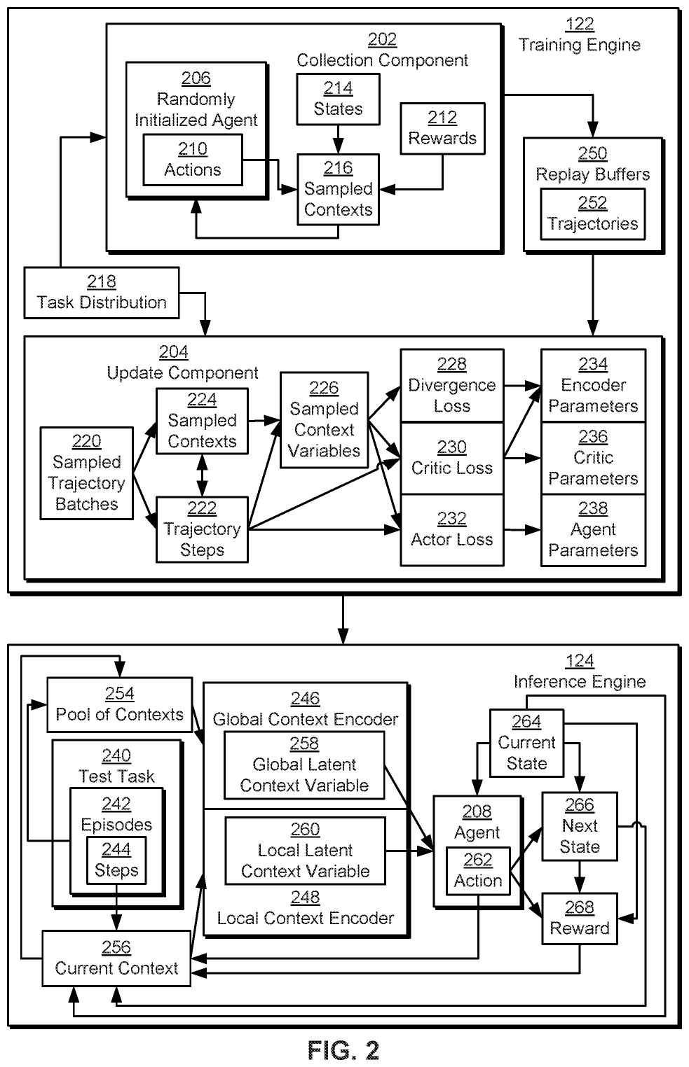

FIG. 2 is a more detailed illustration of training engine 122 and inference engine 124 of FIG. 1, according to various embodiments. As mentioned above, training engine 122 and inference engine 124 operate to train and execute a meta-RL model to solve complex, multi-stage tasks.

In one or more embodiments, the meta-RL model learns to solve tasks from a task distribution 218 represented by p(T). This task distribution 218 may include a family of related tasks, such as navigating spaces with different layouts; operating robots with different physical parameters (e.g., dimensions, joints, geometries, etc.); learning to walk or move in different styles, and/or carrying out different sequences of goals. Each sample from p(T) is represented as a Markov Decision Process (MDP)<S, A, P, r, ρ₀, γ>, where S is the state space, A is the action space, P is the transition probability distribution over new states after an action 262 is taken in a given current state 264, r is the reward function used to calculate a reward 268, ρ₀ is the distribution of initial states, and γ is the discount factor that determines the present value of future rewards. All tasks from p(T) can be assumed to share the same known state and action space but may differ in transition probabilities, reward functions, and initial state distributions, which are unknown but can be sampled.

Within task distribution 218, a given task T includes a collection of contexts (e.g., context 254-256) c^{T}, where each context is a transition tuple sampled from T that includes current state 264 s, action 262 a, reward 268 r, and next state 266 s′ at a given time step i, or {(sᵢ, aᵢ, rᵢ, sᵢ′)}. The meta-RL model includes an RL agent 208, which can be represented by π_{θ}(a|s) (where the agent is parameterized by θ) and trained on a set of training tasks sampled from p(T). In some embodiments, the goal of the training includes adapting agent 208 to a set of unseen tasks sampled from the same task distribution 218, given contexts sampled from the unseen tasks.

In one or more embodiments, the meta-RL model learns to approximate a latent task variable, which can be represented by p(z|T). In the latent task variable, z represents a multi-dimensional encoded representation of task T After posterior inference is performed on the latent task variable, agent 208 performs an action 262 based on current state 264 and the latent task variable. The latent task variable thus captures the uncertainty over the task, which allows quick adaptation and high performance in meta-RL.

However, the true posterior of the latent task variable may be unknown when the transition probability, reward function, and initial state distribution of task T are unknown. Instead, the latent task variable p(z|T) can be approximated by calculating the posterior of a latent context variable p(z|c^{T}), where contexts collected from task T are used as representative samples from the task.

In some embodiments, the true posterior of the latent context variable is estimated by training a context encoder (e.g., global context encoder 246, local context encoder 248) represented by q_{ϕ}(z|c) (and parameterized by ϕ) via amortized variational inference using the following evidence lower bound (ELBO):

[symbol]

[ [symbol] )[R( [symbol] T,z)−βD( [symbol] ,p(z))]], (1)

where p(z) represents the prior distribution of the latent context variable and is defined according to prior knowledge of task distribution 218 (e.g., by users involved in training and/or using the meta-RL model). D(c^{T}, p(z)) represents the Kullback-Leibler (KL) divergence (or another measure of divergence between probability distributions) between prior p(z) and posterior q_{ϕ}(z|c^{T}) R(T, z) is the reconstruction error associated with reconstructing the task from the encoded representation, and β is a trade-off hyperparameter that balances between reconstruction and inference of disentangled factors. This context-based approach disentangles task inference (e.g., by the context encoder) from decision-making (e.g., by agent 208), which allows off-policy data to be used in updating the policies for both task inference and decision-making.

In one or more embodiments, the context encoder includes a combination of global context encoder 246 and local context encoder 248. Global context encoder 246 is used to estimate a global latent context variable 258 for each episode of a given task (e.g., test task 240) given contexts 254 collected from previous episodes 242 of the task, and local context encoder 248 is used to estimate a local latent context variable 258 for each time step (e.g., steps 244) within a given episode based on one or more contexts 256 from previous steps 244 in the same episode. For example, global context encoder 246 may be used to estimate a layout of a maze or a route to be traversed during a given task, and local context encoder 248 may be used to estimate a direction to move at a given time step during navigation of the maze or route. In other words, global context encoder 246 may capture the global structure of the task, such as goal locations, rewards, and/or other parameters associated with the task, and local context encoder 246 may use contexts 256 from previous steps 244 in an episode of the task to capture the current sub-task, such as the current goal to be attained during a given time step of the episode.

To capture the current sub-task and transitions between sub-tasks in a given task, local context encoder 246 outputs the posterior distribution of a multi-dimensional local latent context variable 260 at a current time step after the context at a previous time step is inputted into local context encoder 246. To further encode transitions across a series of time steps, local context encoder 246 may be designed using a recurrent architecture.

For example, local context encoder 260 may be represented using qϕ^{L} and include three components: an inference function represented by q_{ϕ}^{enc}, a transition function represented by q_{ϕ}^{tran}, and a conditional prior represented by q_{ϕ}^{prior}. Local context encoder 260 may additionally be implemented using a variational recurrent neural network (RNN) to model the variability of dependencies between values of local latent context variable 260 across time steps. This variational RNN includes a hidden state that is conditioned on stochastic samples from the posterior distribution of local latent context variable 260 from the previous time step.

Continuing with the above example, given a context cₜ at time step t, local latent context variable 260 zₜ₊₁^{local} may be sampled from the posterior distribution that is calculated using the following:

zₜ₊₁^{local}˜q_{ϕ}^{enc}(z|cₜ,hₜ) (2)

where hₜ denotes the hidden state of the variational RNN at time step t. The hidden state is updated using the following recurrence:

hₜ=q_{ϕ}^{tran}(cₜ₋₁,zₜ^{local},hₜ₋₁) (3)

After the hidden state is updated, agent 208 selects action 262 for the time step by sampling from π_{θ}(a|sₜ, zₜ^{local}), which represents the probability distribution on action 262 that is conditioned on the observation of current state 264 sₜ in the same time step and the updated local latent context variable 260 zₜ^{local}.

At an initial time step t=0 in a given episode, a value of local latent context variable 260 z₀^{local} may be sampled from a predefined uninformative prior, such as an isotropic Gaussian or uniform categorical distribution. After the initial time step, dependencies among distributions of local latent context variable 260 are captured by conditioning the prior distribution of zₜ^{local} on the previous hidden state p(zₜ^{local})=q_{ϕ}^{prior}(hₜ₋) instead of the same uninformative prior, which neglects the temporal structure of the posterior at various time steps 244.

The loss of local context encoder 248 q_{ϕ}^{L} is defined by replacing the KL loss term D(c, p(z)) in Eq. 1 with the following:

$${D}_{K L}^{L o c a l} = {\sum }_{t} {D}_{K L} ( {q}_{ϕ}^{e n c} ( z \vert {c}_{t} , {h}_{t} ) \vert \vert {q}_{ϕ}^{p r i o r} ( {h}_{t} ) ) , \qquad ( 4 )$$

which can be optimized via stochastic gradient descent during meta-training, as described in further detail below.

In one or more embodiments, the computational efficiency and/or resource overhead associated with executing the meta-RL model are improved by reducing the frequency with which local latent context variable 260 is estimated. For example, posterior estimation on local latent context variable 260 may be performed on a subset of timesteps {tr, 2tr, . . . } according to a temporal resolution tr. That is, in Eq. 2, zₜᵣ^{local} may be sampled from q₀^{enc}(z|c_{0:tr-1}, h₀), where c_{0:tr-1} represents concatenated contexts 256 from time step 0 to time step tr−1. In this example, the cost of each posterior sampling can be amortized over tr steps of decision-making. This reduction in posterior estimation may be performed under the assumption that the sub-task in time step t is likely to be very similar to the sub-task in time step t+1, such that local latent context variable 260 that represents the current sub-task at time t is also likely to be accurate enough for decision-making at time step t+1.

While local context encoder 248 uses local latent context variable 260 to infer a local sub-task within a given episode of a task with q_{ϕ}^{L}, global context encoder 246 uses global latent context variable 258 to infer the overall task structure given a pool of past contexts 254 C of size n collected from the same task (but not necessarily the same episode). For example, global context encoder 246 may be represented using q_{ϕ}^{G}(z|cᵢ), which infers the posterior distribution of global latent context variable 258 based on each single past context cᵢ ∈C. This posterior may be calculated by taking the product of each independent posterior q_{ϕ}^{G}(z|C)∞Πᵢq_{ϕ}^{G}(z|cᵢ). Thus, a larger set of past contexts C results in a more accurate global task estimation. To perform inference over the overall task without assuming an ordering of context 256 or goals within episodes 242 of the task, global context encoder 246 may utilize a Deep Sets architecture, which outputs a value of global latent context variable 258 that is permutation-invariant with respect to the pool of contexts 254 C.

In turn, a joint latent space of global latent context variable 258 and local latent context variable 260 may be used to perform online task inference in the meta-RL model. Local latent context variable 260 may be updated online to reason about the sub-task in individual time steps 244 of a given task, and global latent context variable 258 may be updated once per episode of the task to estimate the task. Global context encoder 246 and local context encoder 248 may be jointly trained using ELBO loss. Under the assumption that global latent context variable 258 and local latent context variable 260 are independent, the ELBO used in this training includes Eq. 1 with the KL term decomposed into the sum of two separate terms:

D_{KL}(q_{ϕ}^{G}(z|C)∥p(z))+D_{KL}^{Local} (5)

In one or more embodiments, training engine 122 and inference engine 124 support flexible parameterization of the latent space for both global latent context variable 258 and local latent context variable 260. This flexible parameterization includes, but is not limited to, Gaussian, categorical, Dirichlet, logistic normal, and/or composite distributions. These types of distributions can be used to model multi-modal tasks such as two-dimensional (2D) point robot navigation, which involves a robot navigating to different goal locations on the edge of a half-circle. These types of distributions can also, or instead, be used to model tasks with compositional sub-task structures, such as running in one or more goal directions, running at one or more goal velocities, and/or running to one or more goals in a 2D or three-dimensional (3D) environment.

For example, categorical variables of dimension K may be used for the latent space of global latent context variable 258, and global latent context variable 258 may be calculated as the product of single posterior estimates. In other words, if q_{ϕ}^{G}(z|cᵢ)=[pᵢ₁ . . . , p_{iK}], then q_{ϕ}^{G} (z|C)∞[Πᵢpᵢ₁, . . . , Πᵢp_{iK}]. For numerical stability, q₀^{G}(z|C) can be calculated using [exp Σᵢ log pᵢ₁−cons, . . . , exp Σᵢ log p_{iK}−cons] where cons=maxⱼΣᵢ log pᵢⱼ.

In another example, a Dirichlet distribution may be used to model global latent context variable 258. Here, the probability density function (PDF) of the posterior distribution calculated by global context encoder 246 from a single context cᵢ is calculated using the following:

$${q}_{ϕ}^{G} ( z \vert {c}_{i} ) = \frac{1}{B ( {α}_{i} )} {Π}_{j = 1}^{K} {z}_{j}^{{α}_{ij} - 1} ,$$

where B is the multivariate Beta function parameterized by a vector of positive real numbers αᵢ=(αᵢ₁ . . . , α_{iK}). With n contexts, the product is calculated using the following:

$${Π}_{i = 1}^{n} {q}_{ϕ}^{G} ( z \vert {c}_{i} ) = \frac{1}{{Π}_{i = 1}^{n} B ( {α}_{i} )} {Π}_{j = 1}^{K} {z}_{j}^{{\sum }_{i = 1}^{n} {α}_{ij} - 1}$$

To remain a Dirichlet distribution, the resulting posterior may be required to adhere to the following constraint:

1+Σᵢ₌₁ⁿ(αᵢⱼ−1)>0

Permutation-invariant estimation of the parameters of the posterior distribution of global latent context variable 258 may be achieved using a Deep sets architecture for global context encoder 246, as mentioned above.

In a third example, the latent space for global latent context variable 258 may include logistic normal random variables. Each single posterior estimate (e.g., q_{ϕ}^{G}(z|cᵢ)=[pᵢ₁, . . . , p_{iK}]) of this type of distribution can be treated as a Gaussian distribution. Thus, the Gaussian posterior distribution of a pool of contexts 256 may be calculated as a product of these individual posterior estimates (e.g., q_{ϕ}^{G}(z|C)∞[Πᵢpᵢ₁, . . . , Πᵢp_{iK}]. A softmax function may then be applied to a sample from this product to obtain a sample from the corresponding logistic normal distribution. A Deep sets architecture may also, or instead, be used to calculate the parameters of the posterior of the logistic normal distribution.

In a fourth example, the latent space for global latent context variable 258 and/or local latent context variable 260 may include a composite distribution that includes random variables from different types of distributions mentioned above (e.g., Gaussian, categorical, Dirichlet, logistic normal, etc.). These random variables and/or corresponding distributions may be selected based on prior knowledge of the tasks to be inferred (e.g., a categorical distribution may be used to model discrete types of robots that can be used to perform a task in global latent context variable 258, a Dirichlet distribution may be used to represent a mixture of skills required to perform a task, etc.).

After posterior distributions of global latent context variable 258 and local latent context variable 260 are obtained, the “reparameterization” trick can be used to sample from these distributions. For example, a continuous random variable z with a conditional distribution z˜q_{ϕ}(z|x) can be reparameterized as a deterministic variable z=g_{ϕ}(ε,x) where ε is an auxiliary variable with independent marginal distribution p(ε) and g_{ϕ}(.) is a vector-valued function parameterized by ϕ. When z is a univariate Gaussian random variable (i.e., z˜p(z|x)=N(μ,σ²)), a valid reparameterization is z=μ+σε, where ε˜N(μ, σ²). In another example, samples from a categorical variable z with class probabilities π₁, π₂, . . . , πₖ can be reparameterized using k-dimensional sample vectors y ∈Δ^{k-1}, where

$${p}_{π , τ} ( {y}_{1} , … , {y}_{k} ) = Γ ( k ) {{τ}^{k - 1} ( {\sum }_{i = 1}^{k} {π}_{i} / {y}_{i}^{τ} )}^{- k} {{\prod }^{k}}_{i = 1} ( {π}_{i} / {y}_{i}^{τ + 1} )$$

In a third example, samples from a random variable with Dirichlet distribution parameterized by (α₁, . . . , α_{D}) may be reparameterized using the following:

$$( \frac{{z}_{1}}{{\sum }_{j = 1}^{D} {z}_{j}} , … , \frac{{z}_{D}}{{\sum }_{j = 1}^{D} {z}_{j}} ) ,$$

where zᵢ Gamma(αᵢ, 1).

Training engine 122 includes functionality to train the meta-RL model to perform online task inference. As shown, training engine 122 includes a collection component 202 and an update component 204, which operate to train agent 208, global context encoder 246, and local context encoder 248 to solve tasks in a given task distribution 218. Each of these components is described in further detail below.

Collection component 202 uses a randomly initialized agent 206 (e.g., a deep learning model with randomly initialized parameters) to collect sampled contexts 216 related to a batch of training tasks drawn from task distribution 218. These sampled contexts 216 are used to construct trajectories 252 composed of sequences of “experiences” encountered by randomly initialized agent 206. These trajectories 252 are stored in a number of replay buffers 250 for subsequent use by update component 204.

For example, collection component 202 may initialize parameters of global context encoder 246 and local context encoder 248 using predefined prior distributions. Collection component 202 may also use global context encoder 246 and local context encoder 248 to sample global latent context variable 258 and local latent context variable 260, respectively. Collection component 202 may additionally use randomly initialized agent 206 to select actions 210 based on the sampled global latent context variable 258 and local latent context variable 260 and transition to states 214 encountered during the tasks. Collection component 202 may then update sampled contexts 216 with actions 214, states 214 associated with actions 210, and rewards 212 associated with actions 210 and/or states 214. After a series of sampled contexts 216 is collected for a given episode of a task, collection component 202 may store the series as a trajectory in a replay buffer.

Update component 204 uses sampled trajectory batches 220 from replay buffers 250 to update encoder parameters 234 of global context encoder 246 and local context encoder 248, agent parameters 238 of agent 208, and critic parameters 236 of a critic model used to determine the present value of future rewards for agent 208. In particular, update component 204 may iterate through trajectory steps 222 from each trajectory in sampled trajectory batches 220 and obtain sampled contexts 224 collected during the trajectory. Update component 204 may use sampled context 224 to generate sampled context variables 226 that include values of global latent context variable 258 from global context encoder 246 and local latent context variable 260 from local context encoder 248. Update component 204 may then use sampled context variables 226 and trajectory steps 222 to calculate a divergence loss 228, a critic loss 230, and an actor loss 232 during each training step. At the end of each training step, update component 204 may update encoder parameters 234 of global context encoder 246 and local context encoder 248 using divergence loss 228 and critic loss 230, critic parameters 236 of the critic model using critic loss 230, and agent parameters 238 of agent 208 using actor loss 232.

In one or more embodiments, the operation of collection component 202 and update component 204 is illustrated using the following steps:

Require: Batch of training tasks {Tᵢ} from p(T), learning rates α₁, α₂, α₃, parameters θ, ϕ

| | |
|---|---|
| 1: | Initialize replay buffers Bⁱ for each training task Tᵢ |
| 2: | while not done do |

| | |
|---|---|
| 3: | for each Tᵢ do |

| | |
|---|---|
| 4: | Initialize contexts Cⁱ = { } |
| 5: | for k = 1, ..., K do |

| | |
|---|---|
| 6: | Sample z^{global} ~ q_{ϕ}^{G}(z \| Cⁱ) |
| 7: | for t = 1, ..., T do |

| | |
|---|---|
| 8: | Sample zₜ^{local} ~ q_{ϕ}^{L}(z \| cₜ₋₁,hₜ₋₁) |
| 9: | Gather data from π_{θ}(a \| sₜ,z^{global},zₜ^{local}) and add to Bⁱ |
| 10: | Update cₜ = (sₜ, aₜ, rₜ, sₜ′) |

| | |
|---|---|
| 11: | end for |
| 12: | Update Cⁱ = {(sⱼ, aⱼ, rⱼ, sⱼ′)}_{j:1 ... N} ~ Bⁱ |

| | |
|---|---|
| 13: | end for |

| | |
|---|---|
| 14: | end for |
| 15: | for each step in training steps do |

| | |
|---|---|
| 16: | for each Tᵢ do |

| | |
|---|---|
| 17: | Sample context Cⁱ ~ S_{c}(Bⁱ) and trajectory batch bⁱ ~ Bⁱ |
| 18: | Sample z^{global} ~ q_{ϕ}^{G}(z \| Cⁱ) |
| 19: | Initialize z^{local} = { } |
| 20: | L_{KL}ⁱ = βD_{KL}(q_{ϕ}^{G}(z \| Cⁱ) \|\| p(z)) |
| 21: | for b = 1, ..., B do |

| | |
|---|---|
| 22: | for t = 1, ... , N do |

| | |
|---|---|
| 23: | Sample zₜ^{local} ~ q_{ϕ}^{L}(z \| cₜ₋₁,hₜ₋₁) and add to z^{local} |
| 24: | Update cₜ = (sₜ, aₜ, rₜ, sₜ′) |
| 25: | L_{KL}ⁱ + = βD_{KL}(q_{ϕ}^{L}(zₜ \| cₜ₋₁,hₜ₋₁) \|\| p(z^{local})) |

| | |
|---|---|
| 26: | end for |

| | |
|---|---|
| 27: | end for |
| 28: | L_{actor}ⁱ = L_{actor}(bⁱ,z^{global},z^{local}) |
| 29: | L_{critic}ⁱ = L_{critic}(bⁱ,z^{global},z^{local}) |

| | |
|---|---|
| 30: | end for |

| | |
|---|---|
| 31: | ϕ← ϕ − α₁∇_{ϕ}Σᵢ(L_{critic}ⁱ +L_{KL}ⁱ) |
| 32: | θ_{π} ← θ_{π} − α₂∇_{θ}ΣᵢL_{actor}ⁱ |
| 33: | θ_{Q} ← θ_{Q} − α₃∇_{θ}ΣᵢL_{critic}ⁱ |
| 34: | end for |

| | |
|---|---|
| 35: | end while |

The steps above utilize a batch of training tasks {Tᵢ} from task distribution 218; three learning rates α₁, α₂, α₃ used to update encoder parameters 234, critic parameters 236, and agent parameters 238, respectively; and parameters θ for agent 208 and the critic model and ϕ for global context encoder 246 and local context encoder 248. The first line is used to initialize replay buffers 250 for individual training tasks. The second line specifies a while loop that continues until parameters of agent 208, global context encoder 246, and local context encoder 248 converge and/or another stopping condition is met. Within the while loop, lines 3-14 are performed by collection component 202 and include a first for loop that iterates over the training tasks.

During each iteration of the first for loop, collection component 202 executes line 4 to initialize an empty pool of sampled contexts 216 C for the corresponding training task L. Next, collection component 202 executes a second for loop within the first for loop that spans lines 5-13 and iterates over K episodes of the training task. During each iteration of the second for loop, collection component 202 executes line 6 to sample global latent context variable 258 from global context encoder 246 after inputting the pool of sampled contexts 216 into global context encoder 246.

Collection component 202 then executes a third for loop within the second for loop that spans lines 7-11 and iterates over N time steps of a given episode of the task. During each iteration of the third for loop (i.e., each time step of the episode), collection component 202 executes line 8 to sample local latent context variable 260 from local context encoder 248 after inputting the context cₜ₋₁ and the hidden state of local context encoder 248 hₜ₋₁ from the previous time step into local context encoder 248. Next, collection component 202 executes line 9 to sample an action from randomly initialized agent 206 after inputting the current state, the sampled global latent context variable 258, and the sampled local latent context variable 260 into randomly initialized agent 206. Collection component 202 also adds the sampled action, the current state, the sampled global latent context variable 258, and/or the sampled local latent context variable 260 to the replay buffer for the training task. Collection component 202 then executes line 10 to update the current context cₜ with the current state sₜ, sampled action αₜ, reward rₜ, and next state sₜ′ for the current time step.

After collection component 202 exits the third for loop, collection component 202 executes line 12 to update the pool of sampled contexts 216 for the task and complete one iteration of the second for loop. After execution of the second for loop is complete, collection component 202 repeats lines 3-13 to perform another iteration of the first for loop with a different training task.

After execution of the first for loop spanning lines 3-14 is complete, update component 204 executes a fourth for loop that spans lines 15-34 and is used to train the meta-RL model using data collected by collection component 202. Each iteration of the fourth for loop represents a training step; the training step includes a fifth for loop within the fourth for loop that spans lines 16-30 and iterates over the training tasks.

During each iteration of the fifth for loop, update component 204 executes line 17 to select a pool of sampled contexts 224 C′ MB) and a corresponding trajectory batch bⁱ˜Bⁱ from one or more replay buffers 250 for the corresponding training task. Next, update component 204 executes line 18 to sample global latent context variable 258 from global context encoder 246 after inputting the pool of sampled contexts 224 into global context encoder 246. Update component 204 also initializes an empty set of sampled values for local latent context variable 260 represented by z^{local} in line 18. Update component 204 then executes line 19 to initialize divergence loss 228, represented by L_{KL}ⁱ, to the product of the trade-off hyperparameter β and the KL-divergence between the pre-specified prior distribution of global latent context variable 258 and the posterior outputted by global context encoder 246 from the pool of sampled contexts 224.

In lines 21-27, update component 204 executes a sixth for loop that iterates over trajectories in the trajectory batch within each iteration of the fifth for loop. Update component 204 also executes a seventh for loop that spans lines 22-26 within the sixth for loop to iterate over trajectory steps 222 in each trajectory.

During each iteration of the seventh for loop, update component 204 executes line 23 to sample local latent context variable 260 for the corresponding trajectory step after inputting the context cₜ₋₁ and the hidden state of local context encoder 248 hₜ₋₁ from the previous trajectory step into local context encoder 248. Update component 204 also adds the sampled local latent context variable 260 to the set of sampled values for local latent context variable 260 z^{local} Update component 204 then executes line 24 to update the current context cₜ with the current state sₜ, sampled action aₜ, reward rₜ, and next state sₜ′ for the current time step. Update component 204 additionally executes line 25 to add, to divergence loss 228, the product of β and the KL-divergence between the pre-specified prior distribution of local latent context variable 260 and the posterior outputted by local context encoder 248 from cₜ₋₁ and hₜ₋₁.

After all iterations of the sixth and seventh for loops are complete, update component 204 calculates actor loss 232 in line 28 and calculates critic loss 230 in line 30. In particular, update component 204 calculates both actor loss 232 and critic loss 230 based on the current trajectory batch for the training task and sampled context variables 226 that include the sampled global latent context variable 258 given the corresponding pool of sampled contexts 224 and the set of samples of local latent context variable 260 obtained during individual trajectory steps 222 of the trajectory batch. For example, update component 204 may use a soft actor-critic (SAC) technique to calculate actor loss 232 and critic loss 230 with additional dependence on the sampled values of global latent context variable 258 and local latent context variable 260 as inputs into the policies of agent 208 and the critic model, respectively.

Update component 204 may then perform additional iterations of the fifth for loop to iterate through additional training tasks. After all iterations of the fifth for loop have completed, update component 204 executes lines 31-33 to update encoder parameters 234, agent parameters 238, and critic parameters 236 using stochastic gradient descent. More specifically, update component 204 uses line 31 to update encoder parameters 234 of global context encoder 246 and local context encoder 248 by subtracting, from encoder parameters 234, the product of learning rate α₁ and the gradient of the summed values of divergence loss 228 and critic loss 230 across all training tasks associated with iterations of the fifth for loop. Next, update component 204 uses line 32 to update agent parameters 238 of agent 208 by subtracting, from agent parameters 238, the product of learning rate α₂ and the gradient of actor loss 232 summed across the training tasks. Finally, update component 204 uses line 33 to update critic parameters 236 of the critic model by subtracting, from critic parameters 236, the product of learning rate α₃ and the gradient of critic loss 230 summed across the training tasks.

Update component 204 may perform additional iterations of the fourth for loop to carry out additional training steps that apply gradient updates to encoder parameters 234, critic parameters 236, and agent parameters 238. Finally, update component 204 may perform additional iterations of the outermost while loop until training is complete (e.g., all training tasks have been learned, parameters of the meta-RL model have converged, etc.).

After agent 208, global context encoder 246, and local context encoder 248 are trained on training tasks from task distribution 218, inference engine 124 applies agent 208, global context encoder 246, and local context encoder 248 to a test task 240 from the same task distribution 218. For example, test task 240 may include different goal locations, goal velocities, and/or orderings of goals than training tasks from task distribution 218.

In one or more embodiments, inference engine 124 executes agent 208, global context encoder 246, and local context encoder 248 across multiple episodes 242 of test task 240 and multiple time steps 244 within each episode. A pool of contexts 254 collected from episodes 242 is inputted into global context encoder 246, which outputs a posterior distribution of global latent context variable 258 in response. Similarly, a current context 256 associated with each time step is inputted into local context encoder 248, which outputs a posterior distribution of local latent context variable 260 in response. Samples of global latent context variable 258 and local latent context variable 160 are inputted with current state 264 for a given time step into agent 208, and agent 208 selects a corresponding action 262 for the time step. Current state 264 and/or action 262 are used to determine a corresponding next state 266 for the time step, and current state 264, action 262, and/or next state 266 are used to determine a reward 268 for the time step. Current state 264, action 262, next state 266, and reward 268 are then used to update current context 256 that is inputted into local context encoder 248 at the next time step, as well as pool of contexts 254 that is inputted into global context encoder 246 at the beginning of the next episode.

In one or more embodiments, the operation of inference engine 124 is illustrated using the following steps:

| Require: test task T from p(T) | |
|---|---|
| 1: | Initialize contexts C^{T} = { } |
| 2: | for k= 1, ..., K do |

| | |
|---|---|
| 3: | Sample z^{global} ~ q_{ϕ}^{G}(z \| Cⁱ) |
| 4: | for t = 1, ..., N do |

| | |
|---|---|
| 5: | Sample zₜ^{local} ~ q_{ϕ}^{L}(z \| cₜ₋₁,hₜ₋₁) |
| 6: | Gather data from π_{θ}(a \| sₜ,z^{global},zₜ^{local}) |
| 7: | Update cₜ = (sₜ, aₜ, rₜ, sₜ′) |
| 8: | Accumulate context C^{T} = C^{T} ∪ {cₜ} |

| | |
|---|---|
| 9: | end for |

| | |
|---|---|
| 10: | end for |

The steps above utilize test task 240 T from task distribution 218. The first line is used to initialize an empty pool of contexts 254 C^{T} for test task 240 T. Next, inference engine 124 executes a first for loop that spans lines 2-10 and iterates over K episodes 242 of test task 240. During each iteration of the first for loop, inference engine 124 executes line 3 to sample global latent context variable 258 from global context encoder 246 after inputting pool of contexts 254 into global context encoder 246.

Inference engine 124 then executes a second for loop within the first for loop that spans lines 4-9 and iterates over N time steps 244 of a given episode of test task 240. During each iteration of second for loop (i.e., each time step of the episode), inference engine 124 executes line 5 to sample local latent context variable 260 from local context encoder 248 after inputting current context 256 from the previous time step cₜ₋ᵢ and the hidden state of local context encoder 248 hₜ₋₁ from the previous time step into local context encoder 248. Next, inference engine 124 executes line 6 to sample an action from agent 208 after inputting current state 264, the sampled global latent context variable 258, and the sampled local latent context variable 260 into agent 208. Inference engine 124 then executes line 7 to update current context 256 cₜ for the current time step with the current state sₜ, sampled action aₜ, reward rₜ, and next state sₜ′. Inference engine 124 additionally executes line 8 to add current context 256 to pool of contexts 254.

After inference engine 124 exits the second for loop, inference engine 124 repeats lines 3-9 in another iteration of the first for loop to apply agent 208, global context encoder 246, and local context encoder 248 to another episode of the same test task 240. During early iterations of the first for loop, agent 208 explores the latent space represented by global latent context variable 258 and local latent context variable 260 to collect contexts associated with test task 240. As contexts are added to pool of contexts 254 and/or used to update current context 256, posterior distributions of global latent context variable 258 and local latent context variable 260 become increasingly accurate, and agent 208 quickly converges to the optimal policy for solving test task 240. Moreover, the exploration of agent 208 at the beginning of a given episode may be narrowed to reflect the accumulated pool of contexts 254 used to update global latent context variable 258. Consequently, agent 208 may solve test task 240 more quickly and/or effectively than existing techniques that lack global and local context variables with posterior distributions that are adaptively updated over episodes and time steps and/or that do not support flexible parameterization of the latent space for the context variables.

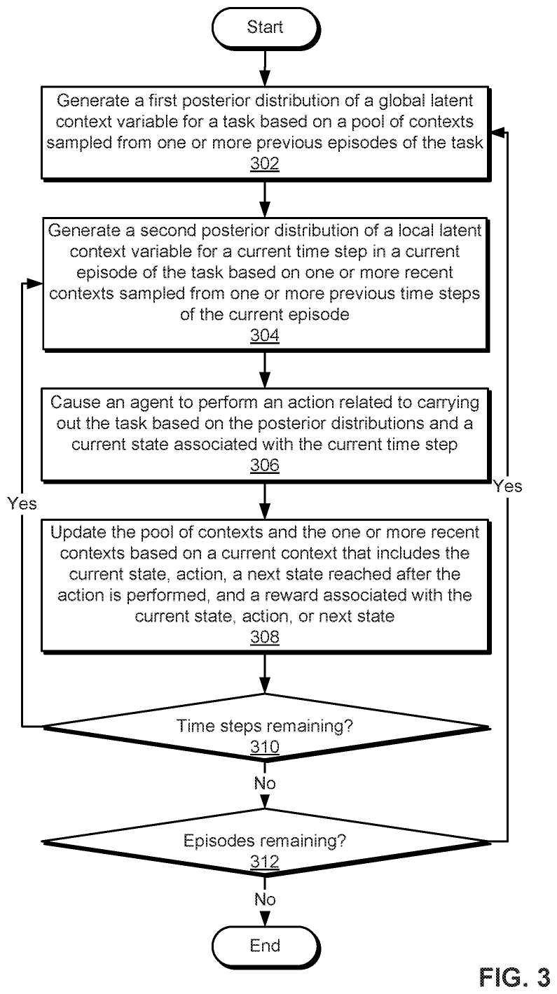

FIG. 3 is a flow chart of method steps for performing a task, according to various embodiments. Although the method steps are described in conjunction with the systems of FIGS. 1 and 2, persons skilled in the art will understand that any system configured to perform the method steps in any order falls within the scope of the present disclosure.

As shown, inference engine 124 generates 302 a first posterior distribution of a global latent context variable for a task based on a pool of contexts sampled from one or more previous episodes of the task. For example, each context in the pool of contexts collected over the previous episode(s) includes a current state, an action, a next state, and a reward associated with a given time step of a corresponding episode. The pool of contexts may be inputted into a Deep Sets architecture and/or another type of global context encoder, and the first posterior distribution of the global latent context variable may be obtained as output of the Deep Sets architecture. If operation 302 is performed during the first episode of the task, the pool of contexts is empty, and the first posterior distribution is equal to the prior distribution of the global context variable.

Next, inference engine 124 generates 304 a second posterior distribution of a local latent context variable for a current time step in a current episode of the task based on one or more recent contexts sampled from one or more previous time steps of the current episode. For example, the recent context(s) may include the most recent context from the previous time step of the current episode. The recent context(s) may be inputted into a variational RNN and/or another type of local context encoder, and the second posterior distribution of the local latent context variable may be obtained as output of the variational RNN. The variational RNN includes a conditional prior for the local latent context variable that is conditioned on a previous hidden state of the variational RNN; a transition component that updates a current hidden state of the variational RNN based on the most recent local context, the conditional prior, and the previous hidden state of the variational RNN; and an inference component that determines the second posterior distribution of the local latent context variable based on the current hidden state of the variational RNN and the local context. If operation 304 is performed during the first time step of the current episode, the local latent context variable is sampled from an uninformative prior such as an isotropic Gaussian or uniform categorical distribution.

As mentioned above, the joint latent space for the global and local latent context variables may be parameterized in a number of different ways. For example, the prior and/or posterior distributions of the global and/or latent context variables may include, but are not limited to, a categorical distribution, a Dirichlet distribution, a logistic normal distribution, and/or a composite distribution.

Inference engine 124 then causes 306 an agent to perform an action related to carrying out the task based on the posterior distributions of the global and latent context variables and a current state associated with the current time step. For example, inference engine 124 may sample the action from a distribution of actions outputted by a policy for the agent given the current state, a first sample from the first posterior distribution of the global latent context variable, and a second sample from the second posterior distribution of the local latent context variable.

After the action is performed, inference engine 124 updates 308 the pool of contexts and the recent context(s) based on a current context that includes the current state, action, a next state reached after the action is performed, and a reward associated with the current state, action, or next state. For example, inference engine 124 may update the most recent context to the current context and/or add the current context to the pool of contexts.

Inference engine 124 may repeat operations 304-308 to iterative over remaining time steps 310 in the same episode. For example, inference engine 124 may iteratively update the second posterior distribution in operation 304 with the most recent context from operation 308 in the previous time step, cause the agent to perform the action in operation 306 using a sample from the updated second posterior distribution, and update the pool of contexts and/or recent context(s) with the most recent current state, action, next state, and reward. As a result, inference engine 124 may advance the agent through a series of time steps in the current episode until a certain number of time steps is reached, the agent has completed the task, and/or another condition is met.

Inference engine 124 may also repeat operations 302-310 to iterate over remaining episodes 312 of the task. For example, inference engine 124 may perform operation 302 at the beginning of each subsequent episode to update the first posterior distribution of the global latent context variable given the pool of contexts accumulated over previous episodes of the task. Inference engine 124 may then use the updated first posterior distribution with iterations of operations 304-310 to generate and/or update the second posterior distribution of the local latent context variable given the recent context(s), perform actions based on the updated posterior distributions of the global and latent context variables and current states associated with time steps in each episode, and update the pool of contexts and/or recent context(s) accordingly. Thus, inference engine 124 may advance the agent through a series of episodes of the task until a certain number of episodes have been performed, the agent has completed the task, the agent's performance in completing the task has stabilized or reached a threshold, and/or another condition is met.

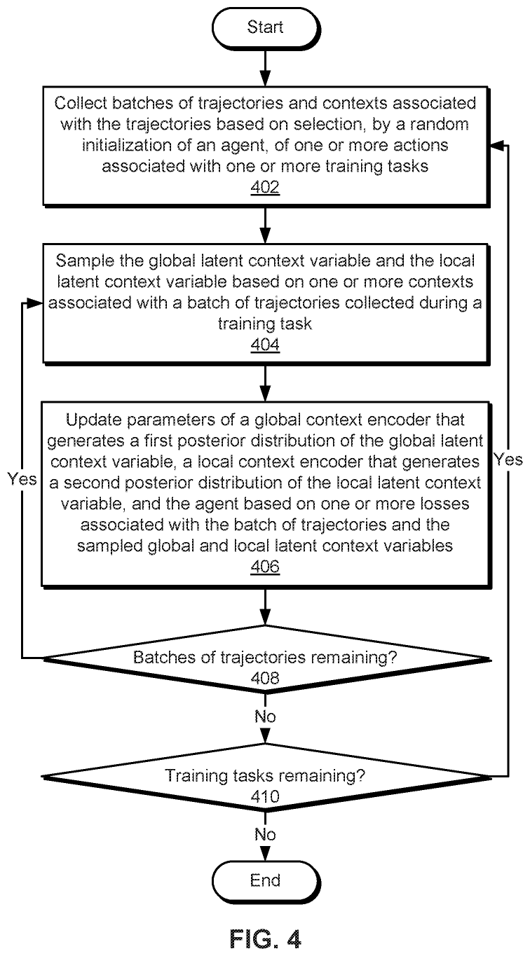

FIG. 4 is a flow chart of method steps for training a meta-reinforcement learning (meta-RL) model, according to various embodiments. Although the method steps are described in conjunction with the systems of FIGS. 1 and 2, persons skilled in the art will understand that any system configured to perform the method steps in any order falls within the scope of the present disclosure.

As shown, collection component 202 collects 402 batches of trajectories and contexts associated with the trajectories based on selection, by a random initialization of an agent, of one or more actions associated with one or more training tasks. For example, collection component 202 may iterate over the training task(s) in a task distribution, one or more episodes of each training task, and/or one or more time steps within each episode. At the beginning of each episode of a training task, collection component 202 may input a pool of contexts collected from previous episodes of the same training task into a global context encoder that models a prior distribution of a global latent context variable to obtain a posterior distribution of the global latent context variable from the global context encoder. At the beginning of each time step of an episode of each training task, collection component 202 may input the most recent context from a previous time step of the same episode into a local context encoder that models a prior distribution of a local latent context variable to obtain a posterior distribution of the local latent context variable from the local context encoder. Collection component 202 may then input samples of the posterior distributions of the global and local latent context variables with a current state at each time step into the randomly initialized agent to obtain an action to be performed at the time step from the agent. Collection component 202 may also determine a current context for the time step as a transition tuple that includes the current state, the action, a next state, and a reward. Finally, collection component 202 updates the pool of contexts, the most recent context, and/or a replay buffer storing a trajectory associated with the current episode of the task with the sampled latent context variables and/or the current context.

Next, update component 204 samples 404 the global latent context variable and the local latent context variable based on one or more contexts associated with a batch of trajectories collected during a training task. For example, update component 204 may sample, from a replay buffer, a batch of trajectories that was collected by collection component 202 in operation 402. Next, update component 204 may sample the global latent context variable from the global context encoder after inputting a pool of contexts collected with the batch of trajectories during episodes of the training task into the global context encoder. Update component 204 may then iterate over a number of time steps in each trajectory from the batch; during each time step, update component 204 may sample the local latent context variable from a recurrent architecture in the local context encoder after inputting the most recent context from a previous time step (or a sample from an uninformative prior for the first time step) into the local context encoder.

Update component 204 then updates 406 parameters of the global context encoder, local context encoder, and agent based on one or more losses associated with the batch of trajectories and the sampled global and local context variables. Continuing with the above example, update component 204 may calculate a divergence loss representing one or more divergences between one or more posterior distributions of the global latent context variable and the local latent context variable and one or more prior distributions of the global latent context variable and the local latent context variable. Update component 24 may also calculate a critic loss and an actor loss based on the batch of trajectories, the sampled global latent context variable, and the sampled local latent context variable. Update component 204 may then update an actor policy containing parameters for controlling the agent based on the actor loss and update a critic policy containing parameters for a critic model that outputs a value function associated with the agent based on the critic loss. Update component 204 may also update parameters of the global and local context encoders based on the critic loss and divergence loss (e.g., a sum of the critic and divergence losses).

Update component 204 may repeat operations 404-406 for some or all remaining batches of trajectories 408 collected during operation 402. For example, update component 204 may continue sampling batches of trajectories from replay buffers populated in operation 402, sampling the global and local latent context variables based on contexts associated with the sampled batches of trajectories, and updating parameters of deep learning and/or other types of machine learning models associated with the agent, critic, context encoders, and/or other components of the meta-RL model based on losses associated with the trajectory batches and sampled context variables until a certain number of trajectory batches has been sampled, all trajectory batches in the replay buffers have been sampled, and/or another condition is met.

Update component 204 may additionally repeat operations 402-408 to collect additional batches of trajectories and train the meta-RL model using the batches for remaining training tasks 410. For example, update component 204 may iteratively train the meta-RL using different sets of training tasks from the same task distribution, increasingly difficult sets of training tasks from the task distribution, and/or other sets of tasks from the task distribution until parameters of the meta-RL converge, the performance of the meta-RL model stabilizes, and/or another condition is met.

### Example Game Streaming System

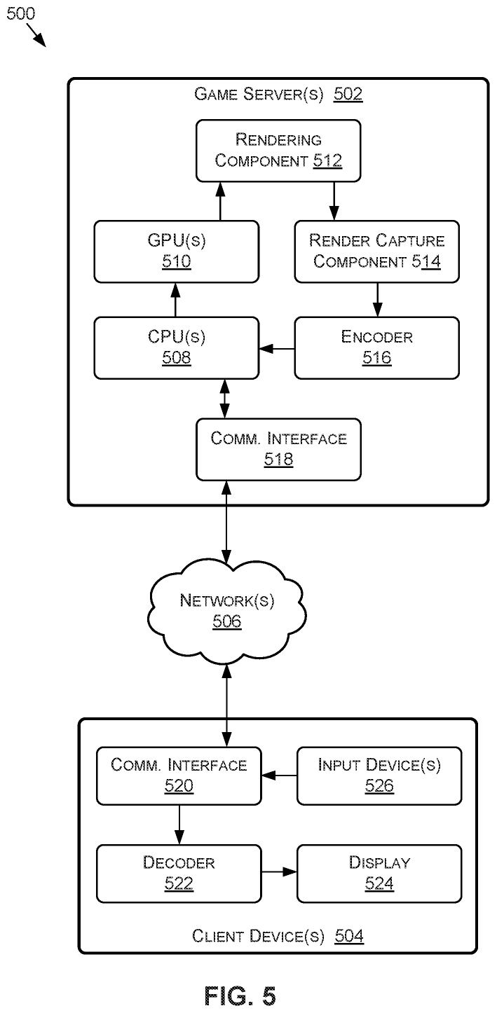

FIG. 5 is an example system diagram for a game streaming system 500, according to various embodiments. FIG. 5 includes game server(s) 502 (which may include similar components, features, and/or functionality to the example computing device 100 of FIG. 1), client device(s) 504 (which may include similar components, features, and/or functionality to the example computing device 100 of FIG. 1), and network(s) 506 (which may be similar to the network(s) described herein). In some embodiments of the present disclosure, system 500 may be implemented using a cloud computing system and/or distributed system.

In system 500, for a game session, client device(s) 504 may only receive input data in response to inputs to the input device(s), transmit the input data to game server(s) 502, receive encoded display data from game server(s) 502, and display the display data on display 524. As such, the more computationally intense computing and processing is offloaded to game server(s) 502 (e.g., rendering—in particular ray or path tracing—for graphical output of the game session is executed by the GPU(s) of game server(s) 502). In other words, the game session is streamed to client device(s) 504 from game server(s) 502, thereby reducing the requirements of client device(s) 504 for graphics processing and rendering.

For example, with respect to an instantiation of a game session, a client device 504 may be displaying a frame of the game session on the display 524 based on receiving the display data from game server(s) 502. Client device 504 may receive an input to one of the input device(s) and generate input data in response. Client device 504 may transmit the input data to the game server(s) 502 via communication interface 520 and over network(s) 506 (e.g., the Internet), and game server(s) 502 may receive the input data via communication interface 518. The CPU(s) may receive the input data, process the input data, and transmit data to the GPU(s) that causes the GPU(s) to generate a rendering of the game session. For example, the input data may be representative of a movement of a character of the user in a game, firing a weapon, reloading, passing a ball, turning a vehicle, etc. Rendering component 512 may render the game session (e.g., representative of the result of the input data), and render capture component 514 may capture the rendering of the game session as display data (e.g., as image data capturing the rendered frame of the game session). The rendering of the game session may include ray- or path-traced lighting and/or shadow effects, computed using one or more parallel processing units—such as GPUs, which may further employ the use of one or more dedicated hardware accelerators or processing cores to perform ray or path-tracing techniques—of game server(s) 502. Encoder 516 may then encode the display data to generate encoded display data and the encoded display data may be transmitted to client device 504 over network(s) 506 via communication interface 518. Client device 504 may receive the encoded display data via communication interface 520, and decoder 522 may decode the encoded display data to generate the display data. Client device 504 may then display the display data via display 524.

In some embodiments, system 500 includes functionality to implement training engine 122 and/or inference engine 124 of FIGS. 1-2. For example, one or more components of game server 502 and/or client device(s) 504 may execute inference engine 124 to generate a first posterior distribution of a global latent context variable for a task (e.g., controlling a character or agent in a game) based on a pool of contexts sampled from one or more previous episodes of the task (e.g., one or more previous sessions of the game). The executed inference engine 124 may also generate a second posterior distribution of a local latent context variable for a current time step in a current episode of the task based on one or more recent contexts sampled at one or more previous time steps of the current episode. The executed inference engine 124 may then cause an agent to perform an action related to carrying out the task based on the first posterior distribution, the second posterior distribution, and a current state associated with the current time step.

In another example, one or more components of game server 502 and/or client device(s) 504 may execute training engine 122 to sample the global latent context variable and the local latent context variable based on one or more contexts associated with a batch of trajectories collected during a training task for the agent. The executed training engine 122 may also update parameters of a global context encoder that generates the first posterior distribution, a local context encoder that generates the second posterior distribution, and the agent based on one or more losses associated with the batch of trajectories, the sampled global latent context variable, and the sampled local latent context variable.

In sum, the disclosed embodiments perform online task inference for compositional tasks with context adaptation. A compositional task includes a sequence of sub-tasks, and online task inference includes inferring the “identity” of the current task or sub-task to be performed based on an agent's past experience with the same task and/or related tasks. To assist with inference of the sub-tasks, context adaptation includes inferring both a global context variable for the task over multiple episodes and a local context variable for individual time steps within each episode of the task. The global context variable may reflect layouts, agent parameters, goal parameters, rewards, and/or other considerations that represent the overall structure of the task, and the local context variable may represent the immediate sub-task to be performed within the overall task. The global context variable, the local context variable, and a current state in the task are then used by the agent to perform an action related to carrying out the task. The global and local contexts thus guide the agent in adapting the actions to the task.

One technological advantage of the disclosed techniques is that the agent converges to an “optimal” policy for solving an unseen task more quickly than conventional techniques that lack the ability to model compositional multi-stage tasks using local and global latent context variables and/or that do not support flexible parameterization of the latent space for the context variables. In turn, the agent consumes fewer resources than conventional RL agents that require more steps and/or computation to solve the same task. Another technological advantage includes more sample-efficient learning of a task distribution, which stems from efficient off-policy update of the meta-RL model and simultaneous training of the agent and encoders for the local and global latent context variables. Consequently, by reducing resource overhead and/or improving performance associated with training and executing the meta-RL model, the disclosed techniques provide technological improvements in computer systems, applications, frameworks, and/or techniques for performing meta-RL and/or online task inference.

1. In some embodiments, a method for performing a task comprises estimating, by one or more neural networks, a type of the task to be performed by an agent based on prior exposure to the task by the agent; estimating, by the one or more neural networks, a current sub-task within the task to be performed by the agent at a current time step based on interaction between the agent and an environment associated with the task at one or more previous time steps; and causing the agent to perform an action related to carrying out the task based on the type of the task, the current sub-task, and a current state associated with the current time step.

2. The method of clause 1, further comprising training the agent and the one or more neural networks based on one or more sequences of experiences encountered by a random initialization of the agent during one or more training tasks.

3. The method of any of clauses 1-2, wherein estimating the type of the task and the current sub-task comprises updating the type of the task and the current sub-task based on a current context comprising a current state, an action, a next state reached after the action is performed, and a reward associated with the current state or the action.

4. In some embodiments, a method for performing a task comprises generating a first posterior distribution of a global latent context variable for the task based on a pool of contexts sampled from one or more previous episodes of the task; generating a second posterior distribution of a local latent context variable for a current time step in a current episode of the task based on one or more recent contexts sampled at one or more previous time steps of the current episode; and causing an agent to perform an action related to carrying out the task based on the first posterior distribution, the second posterior distribution, and a current state associated with the current time step.

5. The method of clause 4, further comprising sampling the global latent context variable and the local latent context variable based on one or more contexts associated with a batch of trajectories collected during a training task for the agent; and updating parameters of a global context encoder that generates the first posterior distribution, a local context encoder that generates the second posterior distribution, and the agent based on one or more losses associated with the batch of trajectories, the sampled global latent context variable, and the sampled local latent context variable.

6. The method of any of clauses 4-5, further comprising collecting the batch of trajectories and the one or more contexts based on selection, by a random initialization of the agent, of one or more actions associated with the training task.

7. The method of any of clauses 4-6, wherein updating the parameters of the first encoder, the second encoder, and the agent comprises updating an actor policy associated with the agent based on an actor loss associated with the batch of trajectories, the sampled global latent context variable, and the sampled local latent context variable; updating a critic policy associated with the agent based on a critic loss associated with the batch of trajectories, the sampled global latent context variable, and the sampled local latent context variable; and updating the global context encoder and the local context encoder based on (i) the critic loss and (ii) a divergence loss representing one or more divergences between one or more posterior distributions of the global latent context variable and the local latent context variable and one or more prior distributions of the global latent context variable and the local latent context variable.

8. The method of any of clauses 4-7, further comprising updating the pool of contexts and the one or more recent contexts based on a current context comprising the current state, the action, a next state reached after the action is performed, and a reward associated with the current state or the action.

9. The method of any of clauses 4-8, wherein generating the first posterior distribution comprises inputting the pool of contexts sampled from the one or more previous episodes of the task into a Deep Sets architecture; and obtaining the first posterior distribution of the global latent context variable as output of the Deep Sets architecture.

10. The method of any of clauses 4-9, wherein generating the second posterior distribution comprises inputting the one or more recent contexts sampled at the one or more previous time steps of the current episode into a variational recurrent neural network; and obtaining the second posterior distribution of the local latent context variable as output of the variational recurrent neural network.

11. The method of any of clauses 4-10, wherein the variational recurrent neural network comprises a conditional prior for the local latent context variable that is conditioned on a previous hidden state of the variational recurrent neural network; a transition component that updates a current hidden state of the variational recurrent neural network based on the one or more recent contexts, the conditional prior, and the previous hidden state of the variational recurrent neural network; and an inference component that determines the second posterior distribution of the local latent context variable based on the current hidden state of the variational recurrent neural network and the one or more recent contexts.

12. The method of any of clauses 4-11, wherein causing the agent to perform the action comprises sampling the action from a distribution of actions outputted by a policy for the agent given the current state, a first sample from the first posterior distribution, and a second sample from the second posterior distribution.

13. The method of any of clauses 4-12, wherein the first posterior distribution or the second posterior distribution comprises at least one of a categorical distribution, a Dirichlet distribution, a logistic normal distribution, or a composite distribution.

14. The method of any of clauses 4-13, further comprising sampling the local latent context variable at an initial time step in the current episode from an uninformative prior.

15. In some embodiments, a non-transitory computer readable medium stores instructions that, when executed by a processor, cause the processor to perform the steps of generating a first posterior distribution of a global latent context variable for the task based on a pool of contexts sampled from one or more previous episodes of the task; generating a second posterior distribution of a local latent context variable for a current time step in a current episode of the task based on one or more recent contexts sampled at one or more previous time steps of the current episode; and causing an agent to perform an action related to carrying out the task based on the first posterior distribution, the second posterior distribution, and a current state associated with the current time step.

16. The non-transitory computer readable medium of clause 15, wherein the steps further comprise collecting one or more batches of trajectories and one or more contexts associated with the one or more batches of trajectories based on selection, by a random initialization of the agent, of one or more actions associated with the training task; sampling the global latent context variable and the local latent context variable based on the collected one or more contexts; and updating parameters of a global context encoder that generates the first posterior distribution, a local context encoder that generates the second posterior distribution, and the agent based on one or more losses associated with the one or more batches of trajectories, the sampled global latent context variable, and the sampled local latent context variable.

17. The non-transitory computer readable medium of any of clauses 15-16, wherein the one or more losses comprise an actor loss associated with the one or more batches of trajectories, the sampled global latent context variable, and the sampled local latent context variable; a critic loss associated with the one or more batches of trajectories, the sampled global latent context variable, and the sampled local latent context variable; and a divergence loss representing one or more divergences between one or more posterior distributions of the global latent context variable and the local latent context variable and one or more prior distributions of the global latent context variable and the local latent context variable.

18. The non-transitory computer readable medium of any of clauses 15-17, wherein generating the first and second posterior distributions comprises updating the first posterior distribution of the global latent context variable given the pool of contexts at the beginning of each episode of the task; and updating the second posterior distribution of the local latent context variable given the one or more recent contexts at the beginning of each time step in each episode of the task.

19. The non-transitory computer readable medium of any of clauses 15-18, wherein generating the first posterior distribution comprises inputting the pool of contexts sampled from the one or more previous episodes of the task into a Deep Sets architecture; and obtaining the first posterior distribution of the global latent context variable as output of the Deep Sets architecture.

20. The non-transitory computer readable medium of any of clauses 15-19, wherein generating the second posterior distribution comprises inputting the one or more recent contexts sampled at the one or more previous time steps of the current episode into a variational recurrent neural network; and obtaining the second posterior distribution of the local latent context variable as output of the variational recurrent neural network.

21. The non-transitory computer readable medium of any of clauses 15-20, wherein causing the agent to perform the action comprises sampling the action from a distribution of actions outputted by a policy for the agent given the current state, a first sample from the first posterior distribution, and a second sample from the second posterior distribution.

22. The non-transitory computer readable medium of any of clauses 15-21, wherein the first posterior distribution or the second posterior distribution comprises at least one of a categorical distribution, a Dirichlet distribution, a logistic normal distribution, or a composite distribution.

23. In some embodiments, a system comprises a memory that stores instructions, and a processor that is coupled to the memory and, when executing the instructions, is configured to generate a first posterior distribution of a global latent context variable for the task based on a pool of contexts sampled from one or more previous episodes of the task; generate a second posterior distribution of a local latent context variable for a current time step in a current episode of the task based on one or more recent contexts sampled at one or more previous time steps of the current episode; and cause an agent to perform an action related to carrying out the task based on the first posterior distribution, the second posterior distribution, and a current state associated with the current time step.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A method for performing a task, comprising:
estimating, by one or more neural networks, a type of the task to be performed by an agent based on prior exposure to the task by the agent;
estimating, by the one or more neural networks, a current sub-task within the task to be performed by the agent at a current time step based on interaction between the agent and an environment associated with the task at one or more previous time steps; and
causing the agent to perform an action related to carrying out the task based on the type of the task, the current sub-task, and a current state associated with the current time step.

2. The method of claim 1, further comprising training the agent and the one or more neural networks based on one or more sequences of experiences encountered by a random initialization of the agent during one or more training tasks.

3. The method of claim 1, wherein estimating the type of the task and the current sub-task comprises updating the type of the task and the current sub-task based on a current context comprising a current state, an action, a next state reached after the action is performed, and a reward associated with the current state or the action.

4. A method for performing a task, comprising:
generating a first posterior distribution of a global latent context variable for the task based on a pool of contexts sampled from one or more previous episodes of the task;
generating a second posterior distribution of a local latent context variable for a current time step in a current episode of the task based on one or more recent contexts sampled at one or more previous time steps of the current episode; and
causing an agent to perform an action related to carrying out the task based on the first posterior distribution, the second posterior distribution, and a current state associated with the current time step.

5. The method of claim 4, further comprising:
sampling the global latent context variable and the local latent context variable based on one or more contexts associated with a batch of trajectories collected during a training task for the agent; and
updating parameters of a global context encoder that generates the first posterior distribution, a local context encoder that generates the second posterior distribution, and the agent based on one or more losses associated with the batch of trajectories, the sampled global latent context variable, and the sampled local latent context variable.

6. The method of claim 5, further comprising collecting the batch of trajectories and the one or more contexts based on selection, by a random initialization of the agent, of one or more actions associated with the training task.

7. The method of claim 5, wherein updating the parameters of the first encoder, the second encoder, and the agent comprises:
updating an actor policy associated with the agent based on an actor loss associated with the batch of trajectories, the sampled global latent context variable, and the sampled local latent context variable;
updating a critic policy associated with the agent based on a critic loss associated with the batch of trajectories, the sampled global latent context variable, and the sampled local latent context variable; and
updating the global context encoder and the local context encoder based on (i) the critic loss and (ii) a divergence loss representing one or more divergences between one or more posterior distributions of the global latent context variable and the local latent context variable and one or more prior distributions of the global latent context variable and the local latent context variable.

8. The method of claim 4, further comprising updating the pool of contexts and the one or more recent contexts based on a current context comprising the current state, the action, a next state reached after the action is performed, and a reward associated with the current state or the action.

9. The method of claim 4, wherein generating the first posterior distribution comprises:
inputting the pool of contexts sampled from the one or more previous episodes of the task into a Deep Sets architecture; and
obtaining the first posterior distribution of the global latent context variable as output of the Deep Sets architecture.

10. The method of claim 4, wherein generating the second posterior distribution comprises:
inputting the one or more recent contexts sampled at the one or more previous time steps of the current episode into a variational recurrent neural network; and
obtaining the second posterior distribution of the local latent context variable as output of the variational recurrent neural network.

11. The method of claim 10, wherein the variational recurrent neural network comprises:
a conditional prior for the local latent context variable that is conditioned on a previous hidden state of the variational recurrent neural network;
a transition component that updates a current hidden state of the variational recurrent neural network based on the one or more recent contexts, the conditional prior, and the previous hidden state of the variational recurrent neural network; and
an inference component that determines the second posterior distribution of the local latent context variable based on the current hidden state of the variational recurrent neural network and the one or more recent contexts.

12. The method of claim 3, wherein causing the agent to perform the action comprises sampling the action from a distribution of actions outputted by a policy for the agent given the current state, a first sample from the first posterior distribution, and a second sample from the second posterior distribution.

13. The method of claim 4, wherein the first posterior distribution or the second posterior distribution comprises at least one of a categorical distribution, a Dirichlet distribution, a logistic normal distribution, or a composite distribution.

14. The method of claim 4, further comprising sampling the local latent context variable at an initial time step in the current episode from an uninformative prior.

15. A non-transitory computer readable medium storing instructions that, when executed by a processor, cause the processor to perform the steps of:
generating a first posterior distribution of a global latent context variable for the task based on a pool of contexts sampled from one or more previous episodes of the task;
generating a second posterior distribution of a local latent context variable for a current time step in a current episode of the task based on one or more recent contexts sampled at one or more previous time steps of the current episode; and
causing an agent to perform an action related to carrying out the task based on the first posterior distribution, the second posterior distribution, and a current state associated with the current time step.

16. The non-transitory computer readable medium of claim 15, wherein the steps further comprise:
collecting one or more batches of trajectories and one or more contexts associated with the one or more batches of trajectories based on selection, by a random initialization of the agent, of one or more actions associated with the training task;
sampling the global latent context variable and the local latent context variable based on the collected one or more contexts; and
updating parameters of a global context encoder that generates the first posterior distribution, a local context encoder that generates the second posterior distribution, and the agent based on one or more losses associated with the one or more batches of trajectories, the sampled global latent context variable, and the sampled local latent context variable.

17. The non-transitory computer readable medium of claim 16, wherein the one or more losses comprise:
an actor loss associated with the one or more batches of trajectories, the sampled global latent context variable, and the sampled local latent context variable;
a critic loss associated with the one or more batches of trajectories, the sampled global latent context variable, and the sampled local latent context variable; and
a divergence loss representing one or more divergences between one or more posterior distributions of the global latent context variable and the local latent context variable and one or more prior distributions of the global latent context variable and the local latent context variable.

18. The non-transitory computer readable medium of claim 15, wherein generating the first and second posterior distributions comprises:
updating the first posterior distribution of the global latent context variable given the pool of contexts at the beginning of each episode of the task; and
updating the second posterior distribution of the local latent context variable given the one or more recent contexts at the beginning of each time step in each episode of the task.

19. The non-transitory computer readable medium of claim 15, wherein generating the first posterior distribution comprises:
inputting the pool of contexts sampled from the one or more previous episodes of the task into a Deep Sets architecture; and
obtaining the first posterior distribution of the global latent context variable as output of the Deep Sets architecture.

20. The non-transitory computer readable medium of claim 15, wherein generating the second posterior distribution comprises:
inputting the one or more recent contexts sampled at the one or more previous time steps of the current episode into a variational recurrent neural network; and
obtaining the second posterior distribution of the local latent context variable as output of the variational recurrent neural network.

21. The non-transitory computer readable medium of claim 15, wherein causing the agent to perform the action comprises sampling the action from a distribution of actions outputted by a policy for the agent given the current state, a first sample from the first posterior distribution, and a second sample from the second posterior distribution.

22. The non-transitory computer readable medium of claim 15, wherein the first posterior distribution or the second posterior distribution comprises at least one of a categorical distribution, a Dirichlet distribution, a logistic normal distribution, or a composite distribution.

23. A system, comprising:
a memory that stores instructions, and
a processor that is coupled to the memory and, when executing the instructions, is configured to:
generate a first posterior distribution of a global latent context variable for the task based on a pool of contexts sampled from one or more previous episodes of the task;
generate a second posterior distribution of a local latent context variable for a current time step in a current episode of the task based on one or more recent contexts sampled at one or more previous time steps of the current episode; and
cause an agent to perform an action related to carrying out the task based on the first posterior distribution, the second posterior distribution, and a current state associated with the current time step.
